(19) United States
(12) Patent Application Publication
(10) Pub. No.: US 2012/0145419 A1
(43) Pub. Date: Jun. 14, 2012

(54) CEILING FIRE EXTINGUISHING SYSTEM

(75) Inventor: Masaei Uchiyama, Sanjo-Shi (JP)

(73) Assignee: UCHIYAMA INDUSTRY CO., LTD., Sanjo-Shi (JP)

(21) Appl. No.: 13/386,106

(22) PCT Filed: Jun. 13, 2011
(86) PCT No.: PCT/JP2011/063493

§ 371 Date: Jan. 20, 2012

(30) Foreign Application Priority Data
Jun. 11, 2010 (JP) 2010-134444

(51) Int. Cl. A62C 35/68

(52) U.S. Cl. 169/51

(57) ABSTRACT

A ceiling fire-extinguishing system capable of preventing a fire-extinguishing equipment from being displaced due to an earthquake. An fire-extinguishing equipment 54 is fixed to a crossbar 56 provided on joist members 4, 5 via a crossbar clamp 57. A fastening means 63 is provided for coupling a horizontal plane portion 61 and a third joist mounting portion 59 together without penetrating the crossbar 56, with a region 62 surrounded with the third joist mounting portion 59, the vertical plane portion 60 and the horizontal plane portion 61, penetrated by the crossbar 56. Hence, the crossbar 56 and the fire-extinguishing equipment 54 can be prevented from being displaced from each other by the shaking caused by the earthquake. Even if displacement has occurred, the installed positions of the crossbar 56 and the fire-extinguishing equipment 54 can be easily corrected by moving the crossbar 56 in its axial direction.

### TECHNICAL FIELD

The present invention relates to an installation structure of a fire-extinguishing equipment installed on a ceiling.

### BACKGROUND ART

Heretofore, there has been known a fire-extinguishing equipment installed on a ceiling of a building to detect a fire and then automatically extinguish the fire from the ceiling or the like.

Now, referring to the conventional installation structure of the fire-extinguishing equipment, it includes a joist support member held in a manner suspended from a ceiling, a joist member fixed to the lower portion of the joist support member, a ceiling panel provided on the lower portion of the joist member, and a fire-extinguishing equipment whose fire-extinguishing unit is installed on the ceiling panel (see patent document 1).

### RELATED ART

### Patent Document

Patent document 1: Japanese unexamined patent application Publication No. 2000-14822

### SUMMARY OF THE INVENTION

### Problems to be Solved by the Invention

According to the installation structure of the fire-extinguishing equipment disclosed in the patent document 1, the arrangement of the joist members and the joist support members which are arranged in a vertically overlapped manner causes the former to quake more largely than the latter when shocks, vibrations or the like due to an earthquake or the like have been applied thereto. Therefore, there has been a problem that when the fire-extinguishing equipment is fixed to the joist support members, the fire-extinguishing unit of the fire-extinguishing equipment is displaced from its installed position relative to the ceiling panel provided on the joist members.

Further, there has been another problem that when strengthening the fixation of the joist members to the joist support members to dampen the quakes of the joist members, concentration of stress occurs at a position where the ceiling and the joist support member are coupled to thereby cause the coupling portion to break, leading to the fall of the joist members and the ceiling panels together with the joist support members.

Furthermore, when the joist members are separated from the joist support members due to the shocks, vibrations, etc. caused by an earthquake or the like and then the ceiling panels fall, then the distance between the fire-extinguishing equipment that still stays in the joist support members and the ceiling panel becomes longer. Hence, there occurs another problem that the heat of flames coming close to the ceiling panels cannot be properly sensed by the fire-extinguishing equipment.

### SUMMARY OF THE INVENTION

### Problems to be Solved by the Invention

The present invention is aimed at solving the foregoing problems and it is, therefore, an object of the present invention to provide a ceiling fire-extinguishing system which prevents its fire-extinguishing equipment from being displaced due to an earthquake or the like.

Further, it is another object of the present invention to provide a ceiling fire-extinguishing system which prevents the ceiling panel from falling.

### Means for Solving the Problems

A first aspect of the present invention is a ceiling fire-extinguishing system including:

a joist support member held in a manner suspended from a ceiling;

a joist member fixed to a lower portion of the joist support member;

a ceiling panel installed on a lower portion of the joist member; and

a fire-extinguishing equipment including a fire-extinguishing unit on the ceiling panel, the fire-extinguishing equipment being fixed to a crossbar installed in the joist member,

wherein a crossbar clamp for fixing the joist member and the crossbar to each other includes:

a joist mounting portion provided in a manner capable of being installed on the joist member;

a first abutting portion provided in a manner capable of being abutted against a lateral face of the crossbar;

a second abutting portion provided in the first abutting portion in a manner capable of being abutted against an upper surface of the crossbar; and

a fastening means for coupling the second abutting portion and the joist mounting portion together, with the crossbar clamp penetrated by the crossbar.

A second aspect of the present invention is the ceiling fire-extinguishing system, in which the joist support member is held in a manner suspended from the ceiling via a suspending member installed on a suspension bolt suspended from the ceiling, and the ceiling fire-extinguishing system further includes: a joist coupling unit provided in the joist member; and a bolt side coupling unit provided in the suspension bolt to couple the joist coupling unit and the bolt side coupling unit together by a coupling means.

A third aspect of the present invention is the ceiling fire-extinguishing system in which the bolt side coupling unit is provided swingably in the suspension bolt.

A fourth aspect of the present invention is the ceiling fire-extinguishing system in which the joist coupling unit provided in the joist member and the joist support member are coupled by a coupling means.

A fifth aspect of the present invention is the ceiling fire-extinguishing system in which the fire-extinguishing equipment includes a bellows tube.

A sixth aspect of the present invention is the ceiling fire-extinguishing system in which a joist coupling unit installed on the joist member includes a joist mounting portion provided in a manner capable of being installed on a groove formed along the longitudinal direction of the joist member and a connecting member for connecting the coupling means for coupling said joist member and a given portion.

A seventh aspect of the present invention is the ceiling fire-extinguishing system in which the connecting member includes an internally threaded portion engageable with an externally threaded portion provided in the coupling means.

### Effects of the Invention

According to the first aspect of the present invention, the crossbar having the fire-extinguishing equipment can be prevented from being displaced from the installed positions of the crossbar and the fire-extinguishing equipment due to the shaking caused by an earthquake or the like.

According to the second aspect of the present invention, even if the ceiling panel is separated from the ceiling due to the shaking of an earthquake or the like, the ceiling panel can be prevented from falling.

According to the third aspect of the present invention, the shocks applied to the coupling means due to the fall of the ceiling panel can be cushioned.

According to the fourth aspect of the present invention, even if the ceiling panel is separated from a ceiling due to the shaking of an earthquake or the like, the ceiling panel can be prevented from falling.

According to the fifth aspect of the present invention, when an earthquake occurs, the fire-extinguishing equipment is allowed to follow the shaking movement of the ceiling panel.

According to the sixth aspect of the present invention, even if the ceiling panel is separated from the ceiling due to the shaking of an earthquake or the like, the ceiling panel can be prevented from falling and besides the joist coupling unit can be easily mounted.

According to the seventh aspect of the present invention, the coupling operation using the coupling means between a joist coupling unit and a given portion can be easily performed.

### BRIEF DESCRIPTION OF THE DRAWINGS

FIG. 1 is a perspective view illustrating a joist holder according to a first embodiment of the present invention.

FIG. 2 is a perspective view illustrating a condition in which a first joist member is installed on the joist holder according to the first embodiment of the present invention.

FIG. 3 is a perspective view illustrating a condition in which a second joist member is installed on the joist holder according to the first embodiment of the present invention.

FIG. 4 is a cross-sectional view illustrating a condition in which the first joist member is installed on the joist holder according to the first embodiment of the present invention.

FIG. 5 is a cross-sectional view illustrating a condition in which the second joist member is installed on the joist holder according to the first embodiment of the present invention.

FIG. 6 is a perspective view illustrating a joist coupling unit according to the first embodiment of the present invention.

FIG. 7 is a perspective view illustrating the usage state of the joist holder according to the first embodiment of the present invention.

FIG. 8 is a perspective view illustrating the vicinity of the joist coupling unit according to the first embodiment of the present invention.

FIG. 9 is a cross-sectional view illustrating a crossbar clamp according to the first embodiment of the present invention.

FIG. 10 is a perspective view illustrating the vicinity of a suspension bolt according to the first embodiment of the present invention.

FIG. 11 is a perspective view illustrating the crossbar clamp according to a second embodiment of the present invention.

FIG. 12 is a cross-sectional view illustrating the crossbar clamp according to the second embodiment of the present invention.

FIG. 13 is a perspective view illustrating a ceiling fire-extinguishing system according to a third embodiment of the present invention.

FIG. 14 is an exploded perspective view illustrating a modification of a bolt side coupling unit according to a fourth embodiment of the present invention.

FIG. 15 is a perspective view illustrating the usage state of the bolt side coupling unit according to the fourth embodiment of the present invention.

FIG. 16 is an exploded perspective view illustrating another modification of the bolt side coupling unit according to a fifth embodiment of the present invention.

FIG. 17 is a perspective view illustrating the usage state of the bolt side coupling unit according to the fifth embodiment of the present invention.

FIG. 18 is an exploded perspective view illustrating a coupling structure according to a sixth embodiment of the present invention.

FIG. 19 is a perspective view illustrating the usage state of the coupling structure according to the sixth embodiment of the present invention.

### MODE FOR CARRYING OUT THE INVENTION

Hereunder is a description of embodiments in the present invention with reference to the accompanied drawings.

### Embodiment 1

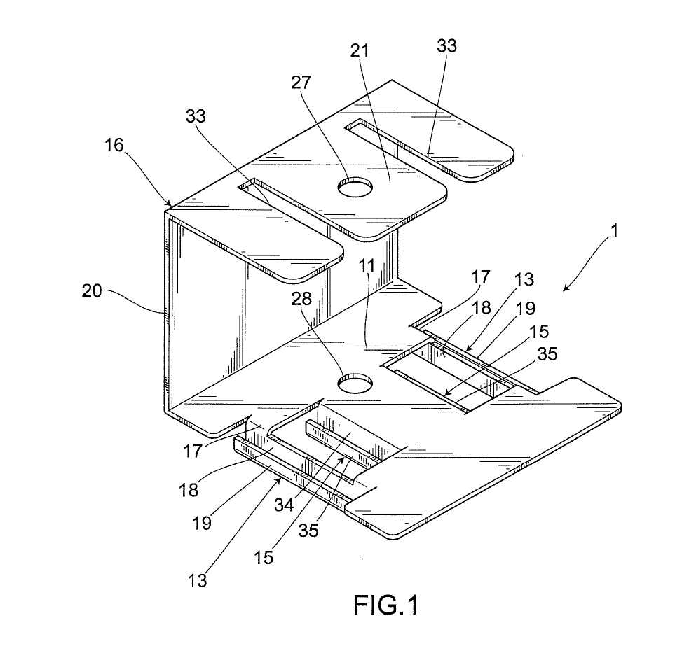

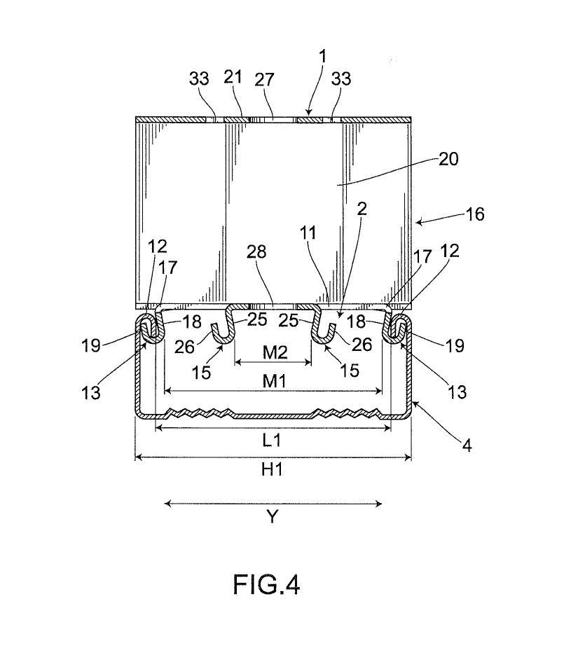

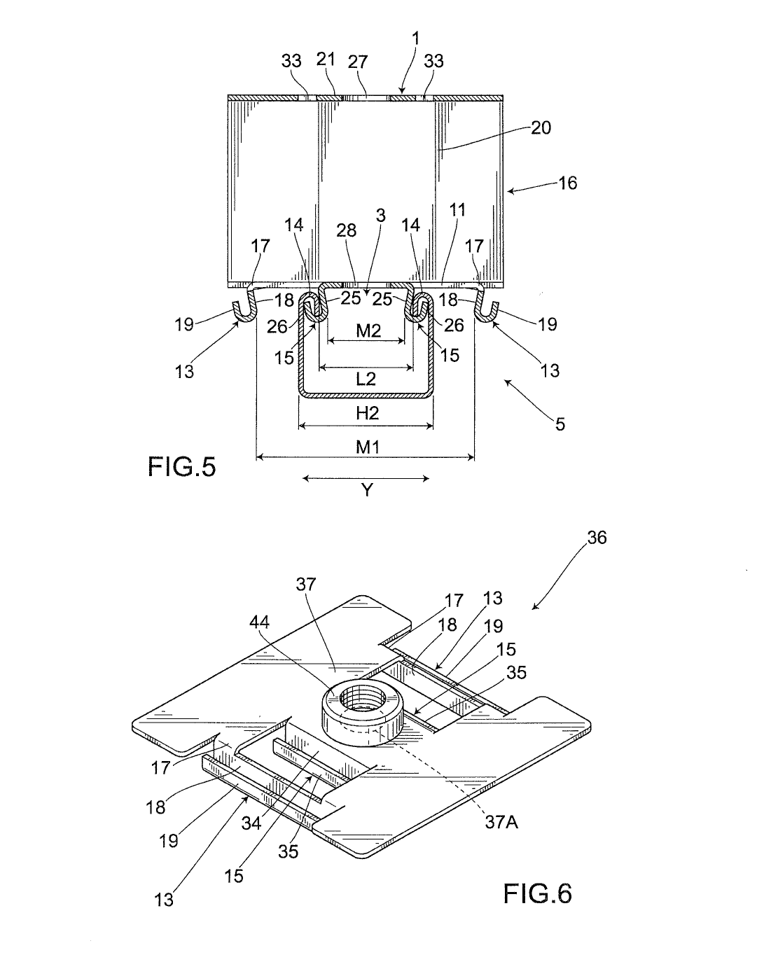

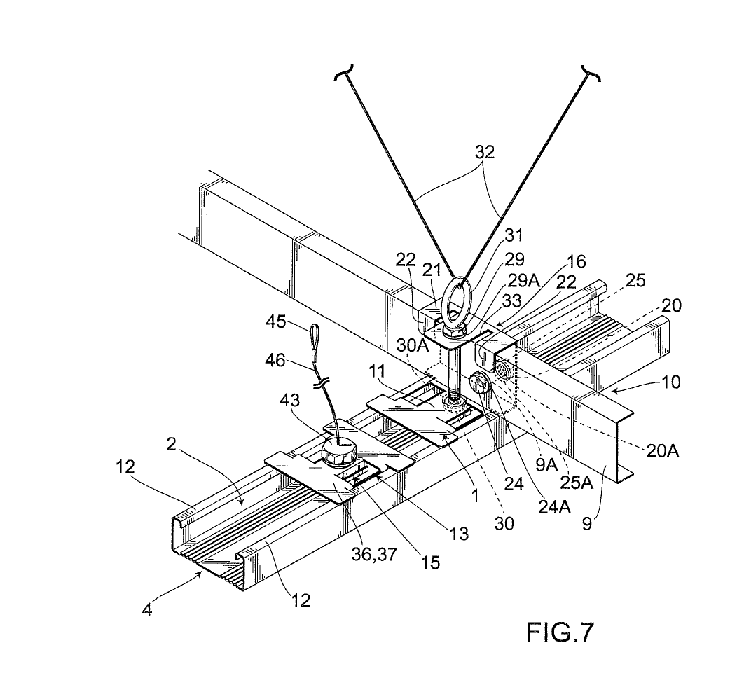

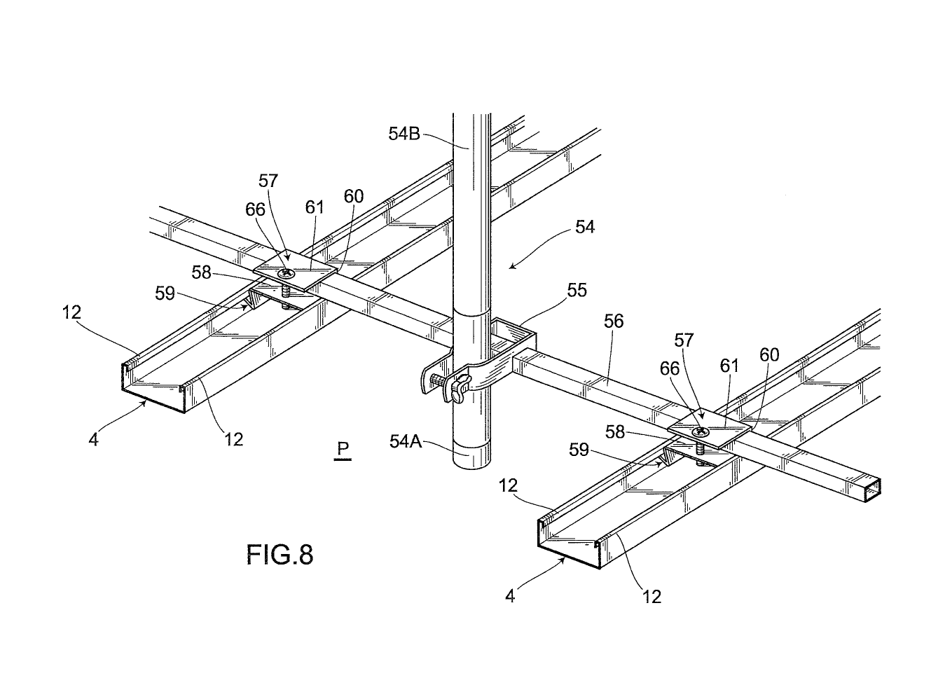

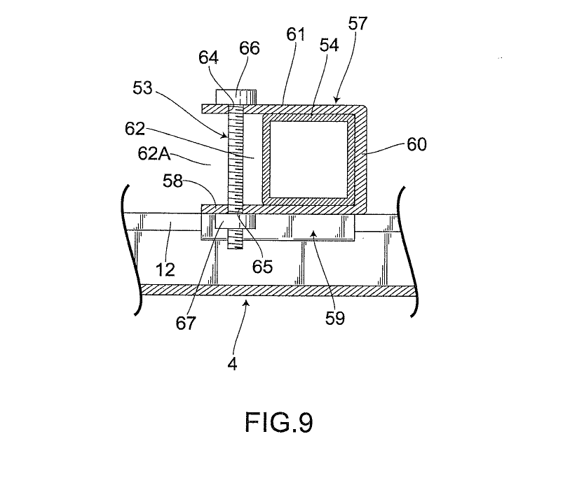

FIG. 1 to FIG. 10 show a first embodiment of the present invention. Joist holders 1 of the present embodiment allow a plurality of joist members 4, 5, having joist grooves 2, 3 formed along the longitudinal directions thereof and made from approximately C-section steels, to be integrated with joist support members 9 made from approximately C-section steels, each being coupled, via a hanger H made from approximately S-shaped steel, to a suspension bolt B as a suspension member suspended from a ceiling R, such that they are arranged at right angles to one another, thus making up a lattice assembly 10 for a ceiling panel P, made from a board material such as a gypsum board, a concrete panel or the like, to be installed on the lower surfaces of the joist members 4, 5.

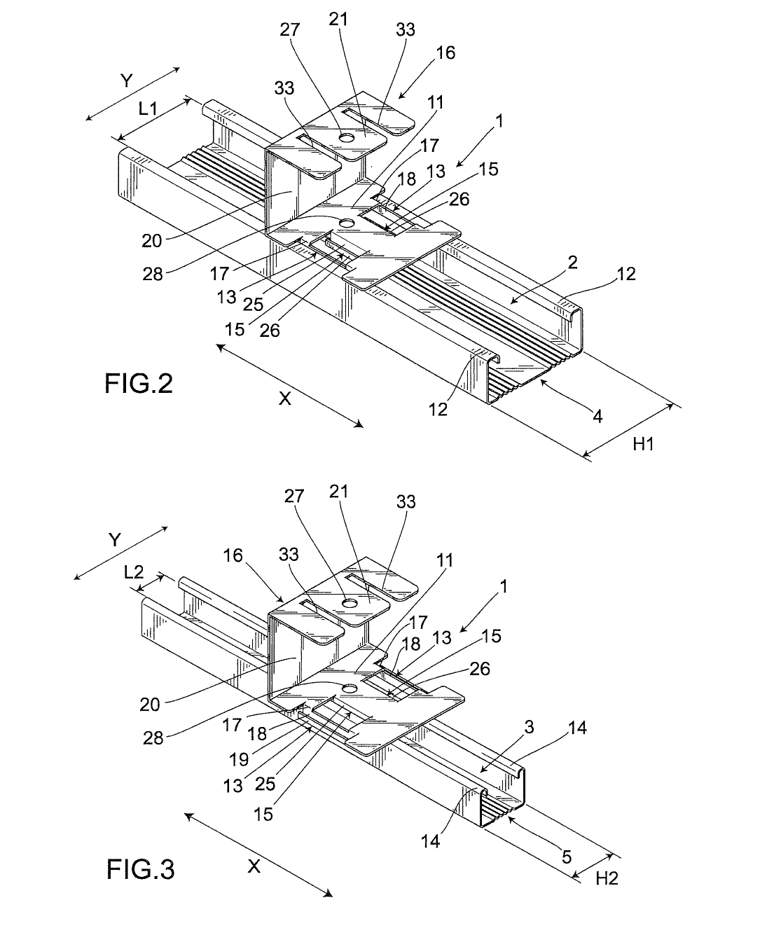

According to the present embodiment, there are two types of joist members whose widths H1, H2 in its shorter direction (i.e., direction Y in FIGS. 2, 3) horizontally orthogonal to its longer direction (direction X in FIGS. 2, 3) are different from each other. Namely, there are employed a first joist member 4 longer in width and a second joist member 5 shorter in width. Here, the width H1 of the first joist member 4 is about twice as large as the width H2 of the second joist member 5.

The joist holder 1 comprises a holder main body 11 made of a rectangular-shaped thin plate of a metal such as stainless steel, aluminum or the like; a first joist mounting portion 13 provided at a lower portion thereof in a manner engageable with approximately J-section first joist bilateral edges 12 in the first joist groove 2 of the first joist member 4; and a second joist mounting portion 15 engageable with approximately J-section second joist bilateral edges 14 in the second joist groove 3 of the second joist member 5.

Above the holder main body 11, the joist holder 1 further includes a support member mounting portion 16 for fixing the joist support member 9 by sandwiching the member 9.

The first joist mounting portion 13 is provided with a pair of first raised portions 18 created by parallelly raising a pair of both ends 17, 17 opposed to each other in the holder main body 11 so as to be insertable into the first joist groove 2 of the first joist member 4, and a first locking portion 19 which is formed to have an approximately J-section by outwardly bending respective tip end of the first raised portions 18 so as to depart from each other in a manner engageable with an inner surface of each of the first joist bilateral edges 12 along the longer direction (the X direction in FIG. 2) to thereby slidably hold the first joist member 4 along the first joist groove 2.

The support member mounting portion 16 includes a support member side raised portion 20 vertically raised from the other edge end of the holder main body that is horizontally orthogonal to the pair of both side ends thereof so as to be approximately parallel to the direction opposite to the first raised portion 18; a sandwiching portion 21 which is formed by approximately horizontally extending an upper end of the support member side raised portion 20 to be made parallel to the holder main body 11 and is opposed to the upper surface thereof; and a support member locking portion 22 formed by bending the tip end of the sandwiching portion 21 in conformity to a lateral shape of the joist support member 9.

Further, the support member mounting portion 16 includes, as a fastening means 23 for fastening the support member side raised portion 20 and the joist support member 9 together, a first bolt 24 acting as a first male screw capable of penetrating a mounting side through-hole 20A formed in the support member side raised portion 20 and a support member through-hole 9A formed in the joist support member 9; and a first nut 25 acting as a first female screw capable of being threadably mounted, from the inside of the joist support member 9, on the first bolt 24 penetrating, from the outer surface of the support member side raised portion 20, the mounting side through-hole 20A and the support member through-hole 9A. Here, the first nut 25 may be fixed to the support member side raised portion 20, or otherwise, it may be prepared separately from the same. Further, instead of using the first female screw 25, either one or both of the mounting side through-hole 20A and the support member side through-hole 9A may be internally threaded in order for the first bolt 24 to be capable of being threadably mounted thereon. Preferably, the first bolt 24 and the first nut 25 may be each installed on the mounting side through-hole 20A or the support member through-hole 9A via washer members 24A, 25A made of soft rubber.

Moreover, the support member mounting portion 16 is provided with, as a fastening unit 26 for enabling the joist support member 9 to be sandwiched by the lower surface of the sandwiching portion 21 and the upper surface of the holder main body 11, a second bolt 29 acting as a second male screw capable of penetrating a sandwiching portion through-hole 27 formed at approximately the center of the sandwiching portion 21 and a holder main body through-hole 28 formed at approximately the center of the holder main body 11, and a second nut 30 acting as a second female screw capable of being threadably mounted, from below the holder main body 11, on the second bolt 29 penetrating the sandwiching portion through-hole 27 and the holder main body through-hole 28 from above the sandwiching portion 21. Here, the second nut 30 may be fixed to the fixing member body 11 or may be prepared separately from the same. Further, instead of using the second female screw 30, either one or both of the sandwiching portion through-hole 27 and the fixing member body through-hole 28 may be internally threaded in order for the second bolt 29 to be threadably mounted thereon. Preferably, the second bolt 29 and the second nut 30 may be each installed on the sandwiching portion through-hole 27 or the fixing member body through-hole 28, via washer members 29A, 30A made of soft rubber.

Besides, the fastening unit 26 includes a first loop 31 provided on the head of the second bolt 29, and a first wire 32 in which its one side is coupled to the first loop 31 and its other side is coupled to a ceiling R to thereby couple the ceiling R and the loop 31 together and thus acts as a swing motion preventing means.

Further, the foregoing support member locking portion 22 is formed by downwardly bending both ends of the distal area of the sandwiching portion 21 compartmented by two slits 33, 33 formed in parallel from the distal area of the sandwiching portion 21 up to the intermediary portion thereof.

The second joist mounting portion 15 is provided with a pair of second raised portions 34, 34 which are raised approximately in parallel to the first raised portions 18 between the first raised portions 18, 18 of the holder main body 11 and are formed at an interval M2 narrower than an interval M1 between the first raised portions 18, 18 so as to be insertable into the second joist groove 3; and a second locking portion 35 which is formed by outwardly bending the respective tip ends of the second raised portions 34, 34 so as to depart from each other in a manner engageable with the inside surface of the second joist bilateral edges 14 along the longer direction (the X direction in FIG. 3) of the second joist member 5 to thereby slidably hold the second joist member 5 along the joist groove 3.

Here, each of the first raised portions 18, 18 is formed aslope so as to get closer to each other, from the basal portion at its holder main body 11 side to the tip end of its first locking portion 19 side. In a similar fashion with respect to third raised portions 40, 40 and the second raised portions 34, 34, they are formed aslope so as to get closer to each other from the basal end of their holder main body 11 side to the respective tip ends of their third locking portions 41, 41 side and second locking portions 35, 35 side.

According to the present embodiment, a joist coupling unit 36 includes the first joist mounting portion 13 and the second joist mounting portion 15, which are similar to those in the joist holder 1, provided on the lower portion of a joist coupling body 37 made of a thin plate of a metal such as rectangular-shaped stainless steel, aluminum or the like. The joist coupling unit 36 further includes a third bolt 43 acting as a third male screw capable of penetrating a through-hole 37A formed at the center of the joist coupling body 37, and a third nut 44 acting as a female screw for allowing the third bolt 43 to be threadably installed on the joist coupling body 37. A wire member 46 having a loop 45 at its end is attached to the head of the third bolt 43. Here, the third nut 44 may be fixed to the joist coupling body 37, or otherwise, may be prepared separately from the same. Alternatively, instead of using the female screw 44, the through-hole 37A may be internally threaded so that the third bolt 43 can be threadably mounted thereon. Preferably, the third bolt 43 and the third nut 44 may each be installed on the through-hole 37A via washer members (not shown) made of soft rubber.

Here, as a feature of the present embodiment, there is provided a crossbar clamp 57 for fixing, to the joist members 4, 5, a crossbar 56 which has a rectangular cross-section and fixes, via a clamp 55, a fire-extinguishing equipment 54 such as a sprinkler having a sprinkler head 54A in its extremity and coupled to a bellows tube (flexible tube) 54B.

Here, the crossbar clamp 57 includes: a clamp main body 58 made of a thin plate of a metal such as rectangular-shaped stainless steel, aluminum or the like; a third joist mounting portion 59 provided on the lower portion thereof and structured in the same manner as the first joist mounting portion 13; a vertical plane portion 60 formed by vertically upwardly raising one side of the clamp main body 58 orthogonal to the third joist mounting portion 59; and a horizontal plane portion 61 which is formed by approximately horizontally extending the upper end of the vertical plane portion 60 so as to be made parallel to the clamp main body 58 and opposed to the upper surface of the clamp main body 58. A region 62 surrounded by the third joist mounting portion 59, the vertical plane portion 60 and the horizontal plane portion 61 is formed larger than the cross-sectional area of the crossbar 56, thus enabling the crossbar 56 to penetrate the region 62.

The crossbar clamp 57 includes, as a fastening means 63 capable of sandwiching the crossbar 56 by the lower surface of the horizontal plane portion 61 and the upper surface of the clamp main body 58 with the region 62 penetrated by the crossbar 56, a fourth bolt 66 acting as a fourth male screw capable of penetrating the horizontal plane through-hole 64 formed at approximately the center of the horizontal plane portion 61 and a mounting portion through-hole 65 formed at approximately the center of the clamp main body 58; and a fourth nut 67 acting as a fourth female screw capable of being threadably mounted, from below the clamp main body 58, on the fourth bolt 66 penetrating the horizontal plane through-hole 64 and the mounting portion through-hole 65 from above the horizontal plane portion 61.

Here, in order that the fourth bolt 66 may not penetrate the crossbar 56, both the horizontal plane through-hole 64 and the mounting portion through-hole 65 are provided on the open side 62A of the region 62 opposite to the vertical plane portion 60, i.e., in a region excluding those in contact with the crossbar 56. Here, the fourth nut 67 may be fixed to the clamp main body 58, or otherwise, may be prepared separately from the same. Further, instead of using the fourth female screw 67, either one or both of the horizontal plane through-hole 64 and the mounting portion through-hole 65 may be internally threaded in order for the fourth bolt 66 to be capable of being threadably mounted thereon. Furthermore, the fourth bolt 66 and the fourth nut 67 are desirably installed on the horizontal plane through-hole 64 and the mounting portion through-hole 65, respectively, via washer members made of soft rubber.

Besides, a bolt side coupling unit 68 is mounted above a hanger H of a suspension bolt B and is coupled to the joist coupling unit 36 via a wire member 46.

The bolt side coupling unit 68 includes a coupling unit main body 71 having a short piece 69 and a long piece 70 that are provided by bending a metallic thin plate to be formed into an approximately J shape; a flange 72 which is formed so as to be capable of being locked to the thread ridge of the suspension bolt B by inwardly extending both edges of an approximately semicircular-arc-shaped folded portion of the coupling unit main body 71; a narrowed portion 73 formed by inwardly depressing the central portion of the short piece 69; a short piece through-hole 74 provided on a more distal side than the narrowed portion 73 of the short pieces 69; a long piece through-hole 75 provided at approximately the center of the long piece 70; and an elongate hole 76 which is located on more distal side than the long piece through-hole 75 of the long piece 70 and is parallel to the longitudinal direction of the long piece 70. Further, the bolt side coupling unit 68 includes a winged screw 77 acting as a fifth male screw capable of penetrating the short piece through-hole 74 and the long piece through-hole 75; and a fifth nut 78 acting as a fifth female screw capable of being threadably installed on the winged screw 77.

Besides, the bolt side coupling unit 68 includes a coupling body 81 swingably installed on the elongate hole 76 in the coupling unit main body 71 via a sixth bolt 79 acting as a sixth male screw and a sixth nut 80 acting as a sixth female screw.

The coupling body 81 is a metallic hollow column hexagonal in cross section and one side of the coupling body 81 includes a through-hole 82 through which the fifth bolt 79 can pass and the other side thereof includes a pair of through-holes 83, formed in the diametrical direction of the coupling body 81. Then, the wire member 46 is allowed to penetrate the through-holes 83 to couple the joist coupling unit 36 and the bolt side coupling unit 68 together.

Next is a description of the behavior of the foregoing structure. First, a description is given of how a lattice assembly 10 is assembled by integrating the first joist member 4 with the joist support member 9. The first raised portions 18 of the joist holder 1 are inserted into the first joist grooves 2 of the first joist member 4 to allow the first locking portion 19 to engage with the inside surfaces of the first joist bilateral edges 12 along the longitudinal direction (X direction in FIG. 2) of the first joist member 4, thus holding the first joist member 4 slidably along the first joist groove 2.

Further, the joist support member 9 is allowed to penetrate the inside of the space compartmented in a C-shaped manner by the support member side raised portion 20, the sandwiching portion 21, and the holder main body 11. After allowing the upper surface and lower surface of the joist support member 9 to be opposed to the lower surface of the sandwiching portion 21 of the support member mounting potion 16 and the upper surface of the holder main body 11, respectively, one lateral side of the joist support member 9 and the support member side raised portion 20 are fixed by fastening the first bolt 24 and the first nut 25 that act as the fastening means 23. Besides, by fastening the second bolt 29 and the second nut 30 acting as the fastening unit 26, the upper and lower surfaces of the joist support member 9 are sandwiched by the lower surface of the sandwiching portion 21 and the upper surface of the holder main body 11. Further, the distal end of the sandwiching portion 21 is bent to form the support member locking portion 22, and thus the support member locking portion 22 is fastened to the lateral side of the joist support member 9, to thereby fix the joist support member 9 to the support member mounting portion 16.

In this manner, the first joist member 4 and the joist support member 9 are arranged orthogonal to each other through the joist holder 1 to thereby assemble the integrated lattice assembly 10, so that the ceiling panel P is mounted on the lower surface of the first joist member 4.

Here, when the second joist member 5 and the joist support member 9 are integrated to assemble the lattice assembly 10, the second raised portion 25 of the joist holder 1 is inserted into the second joist groove 3 of the second joist member 5 to engage the second locking portion 35 with the second joist bilateral edges 14. Then, the second joist member 5 is held slidably along the second joist groove 3 to arrange the second joist member 5 orthogonal to the joist support member 9, so that the integrated lattice assembly 10 is assembled, to set up the ceiling panel P on the lower surface of the second joist member 5. It may be appropriately varied depending on the weight of the ceiling panel P set up on the lower surface of the lattice assembly 10 which of the first or second joist member 4, 5 is used when assembling the lattice assembly 10.

By allowing the fastening means 63 to fixedly sandwich the crossbar 56 between the horizontal plane portion 61 and the third joist mounting portion 59, the crossbar 56 having the fire-extinguishing equipment 54 can be prevented from being displaced from the respective installed positions due to the shaking caused by earthquakes or the like.

Besides, the fastening means 63 includes the fourth bolt 66 with the fourth bolt 66 not penetrating the crossbar 56, and fixedly sandwiches, in an axially movable manner, the crossbar 56 between the horizontal plate 61 and the third joist mounting portion 59. Hence, when the shaking caused by an earthquake or the like has occurred, the crossbar 56 is allowed to axially move via the crossbar clamp 57, while the joist members 4, 5 and the crossbar 56 are allowed to mutually slide because the joist members 4, 5 are slidably held along the third joist mounting portion 59, thereby making it possible to provide the cushioning ability to disperse a force applied by the shaking of an earthquake to the joist members 4, 5 and the crossbar 56. Even when the shaking caused by an earthquake or the like displaces the crossbar 56 and the fire-extinguishing equipment 54 from their installed positions, the installed positions of the crossbar 56 and the fire-extinguishing equipment 54 can be easily corrected by moving the crossbar in its axial direction.

By coupling the joist members 4, 5 and the suspension bolt B via the wire member 46, even if the hanger H is broken by the shaking of an earthquake or the like so that the ceiling panel P, together with the lattice assembly 10, is broken away from the ceiling R, yet the ceiling panel P can be prevented from falling. In this case, the crossbar 56 to which the fire-extinguishing equipment 54 is fixed is fastened to the joist members 4, 5 having the ceiling panel P, and hence a sprinkler head 54A of the fire-extinguishing equipment 54 installed on the ceiling panel P is allowed to become less likely to be displaced from its originally installed position even if the ceiling panel falls. Hence, the heat due to flames coming closer up to the vicinity of the ceiling panel P can be properly detected by the sprinkler head 54A, thus preventing the extinguishing operation performed by the fire-extinguishing equipment 54 from being obstructed by the falling of the ceiling panel P.

Further, the coupling body 81 is swingably mounted in relation to the suspension bolt B. Hence, it is possible to cushion the shock applied to the wire member 46 for coupling the crossbar 56 falling together with the ceiling panel P and the suspension bolt B.

As described above, according to the present embodiment, the fire-extinguishing system on the ceiling includes the joist support member 9 held in a manner suspended from the ceiling R, the joist members 4, 5 fixed to the lower portion of the joist support member 9 via the joist holder 1 acting as a joist fixing member, the ceiling panel P provided on the lower portions of the joist members 4, 5, and the fire-extinguishing equipment 54 having the fire-extinguishing unit 54A on the ceiling panel P, in which the fire-extinguishing equipment 54 is fixed to the crossbar 56 set up, via the crossbar clamp 57, in the joist members 4, 5. The crossbar clamp 57 includes the third joist mounting portion 59 provided in a manner capable of being installed on the grooves 2, 3 formed along the longitudinal directions of the joist members 4, 5, the vertical plane portion 60 abuttable against the lateral side of the crossbar 56, and the horizontal plane portion 61 abuttable against the upper surface of the crossbar 56 provided on the vertical plane portion 60. The fire-extinguishing system on the ceiling further includes the fastening means 63 for coupling the horizontal plane portion 61 and the third joist mounting unit 59 together without penetrating the crossbar 56, with the region 62, surrounded with the third joist mounting portion 59, the vertical plane portion 60 and the horizontal plane portion 61, penetrated by the crossbar 56.

In this case, the crossbar 56 having the fire-extinguishing equipment 54 can be prevented from being displaced from each other by the shaking caused by an earthquake or the like.

Further, according to the present embodiment, the joist support member 9 is held in a manner suspended from the ceiling R via the hanger H acting as a suspending member installed on the suspension bolt B suspended from the ceiling R. The fire-extinguishing system on the ceiling further includes the joist coupling unit 36 provided in the joist members 4, 5 and the bolt side coupling unit 68 provided in the suspension bolt B, so that the joist coupling unit 36 and the bolt side coupling unit 68 are coupled by the wire member 46 acting as a coupling means.

In this case, even if the hanger H is broken by the shaking of an earthquake or the like and the ceiling panel P makes a breakaway from the ceiling R, the ceiling panel P can be prevented from falling.

Furthermore, according to the present embodiment, the bolt side coupling unit 68 is provided swingably in the suspension bolt B. Hence, the shock applied to the wire member 46 due to the fall of the ceiling panel P can be cushioned.

Moreover, according to the present embodiment, the fire-extinguishing equipment 54 includes a bellows tube 54B to allow the sprinkler head 54A of the fire-extinguishing equipment 54 to follow the shaking movement of the ceiling panel P, enabling the shock applied to the fire-extinguishing equipment 54 to be cushioned.

### Embodiment 2

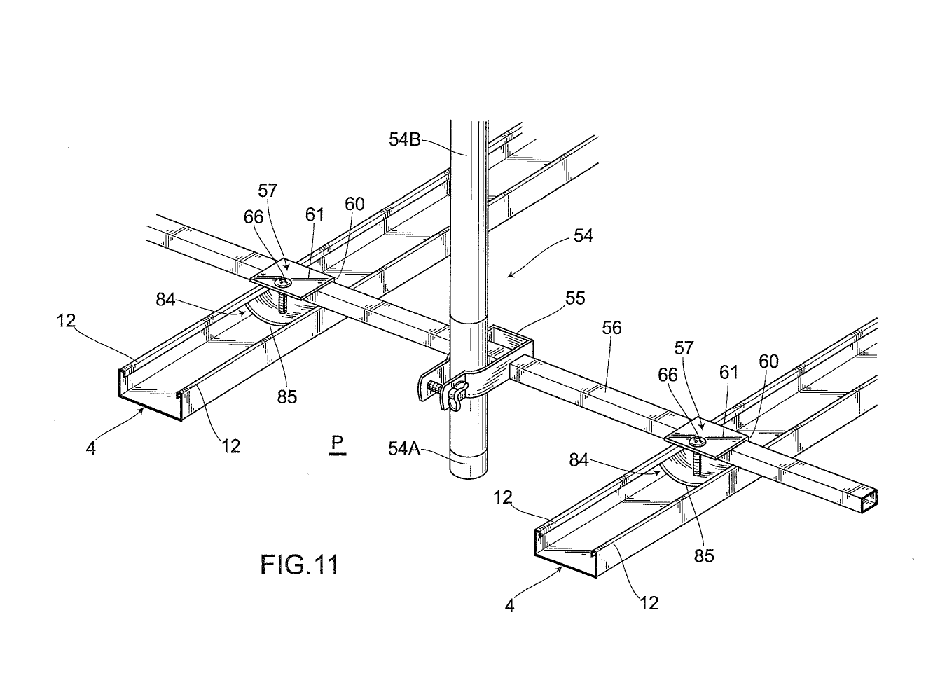

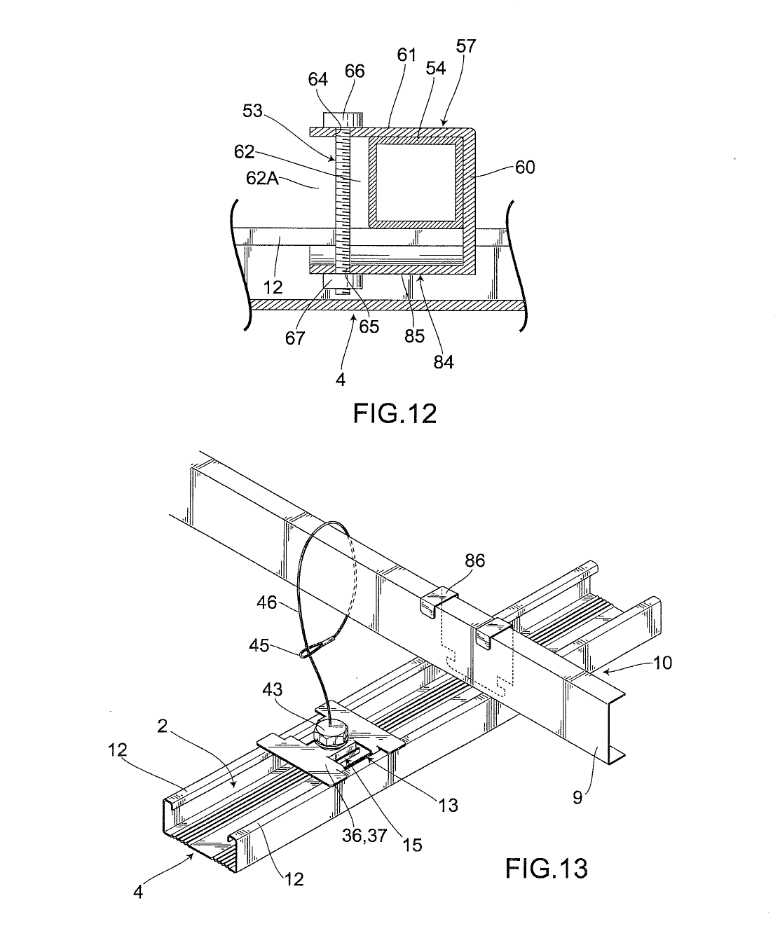

Next, FIG. 11 and FIG. 12 show a second embodiment of the present invention. In the figures, the same symbols are attached to parts the same as in FIG. 1 to FIG. 10 and the detailed descriptions of common parts are omitted.

According to the present embodiment, as a modified example of the crossbar clamp 57, there is provided, in place of the third joist mounting unit 59a, a joist mounting unit 84 created by forming a rectangular plate material made of a metal such as stainless steel, aluminum or the like in an approximately C shape in cross section. When the joist mounting unit 84 is housed in the joist members 4, 5 with approximately the center of a convexly curved surface 85 of the joist mounting unit 84 being opposed to the inner surface of the upper surface of the joist members 4, 5, both the ends in the short direction of the joist mounting unit 84 are provided engageably with the inner surfaces of the joist bilateral edges 12, 14 of the joist members 4, 5 along the longitudinal directions (Y direction in FIG. 11) of the joist members 4, 5, so that the joist members 4, 5 can be held slidably along the joist bilateral edges 12, 14. Besides, at the center of the joist mounting unit 84, a threaded hole 66 is formed engageably with a fourth bolt 66.

### Embodiment 3

Next, FIG. 13 shows a third embodiment of the present invention. In the figure, the same symbols are attached to parts the same as in FIG. 1 to FIG. 12 and the detailed descriptions of common parts are omitted.

According to the present embodiment, in place of the joist holder 1, a well-known clip 86 is employed to fix the joist members 4, 5 and the joist support member 9 to each other. Then, the wire member 46 attached on the head of the third bolt 43 is coupled directly to the joist support member 9.

In this fashion, by coupling the joist members 4, 5 and the joist support member 9 together via the wire member 46, even if the clip 86 is damaged by the shaking of an earthquake or the like, and the ceiling panel P, together with the joist members 4, 5, makes a breakaway from the joist support member 9, yet the ceiling panel P can be prevented from falling. In this case, the crossbar 56 to which the fire-extinguishing equipment 54 is fixed is fixed to the joist members 4, 5 having the ceiling panel P and hence the sprinkler head 54A of the fire-extinguishing equipment 54 installed on the ceiling panel P becomes less likely to be displaced from its installed position with respect to the ceiling panel P even if the ceiling panel P falls. Hence, the heat due to flames closing in the vicinity of the ceiling panel P can be properly detected by the sprinkler head 54A, thus preventing an extinguishing operation performed by the fire-extinguishing equipment 54 from being obstructed by the falling of the ceiling panel P.

As described above, according to the present embodiment, the joist coupling unit 36 provided in the joist members 4, 5 and the joist support member 9 are coupled by the wire member 46 acting as a coupling means. Hence, even if the clip 86 is broken by the shaking of an earthquake or the like to allow the ceiling panel P, together with the lattice assembly 10, to make a breakaway from the ceiling R, the ceiling panel P can be prevented from falling.

Further, according to each of the embodiments described above, even if the ceiling panel P is separated from the ceiling R, the ceiling panel P is held in a manner suspended from the ceiling R by the bellows tube (flexible tube) 54B of the fire-extinguishing equipment 54 fixed to the crossbar 56 via the crossbar clamp 57 or the wirings (not shown) of illuminating devices and, air-conditioning systems and etc. which are installed on the ceiling panel P, thereby preventing the ceiling panel P from falling on the ground.

### Embodiment 4

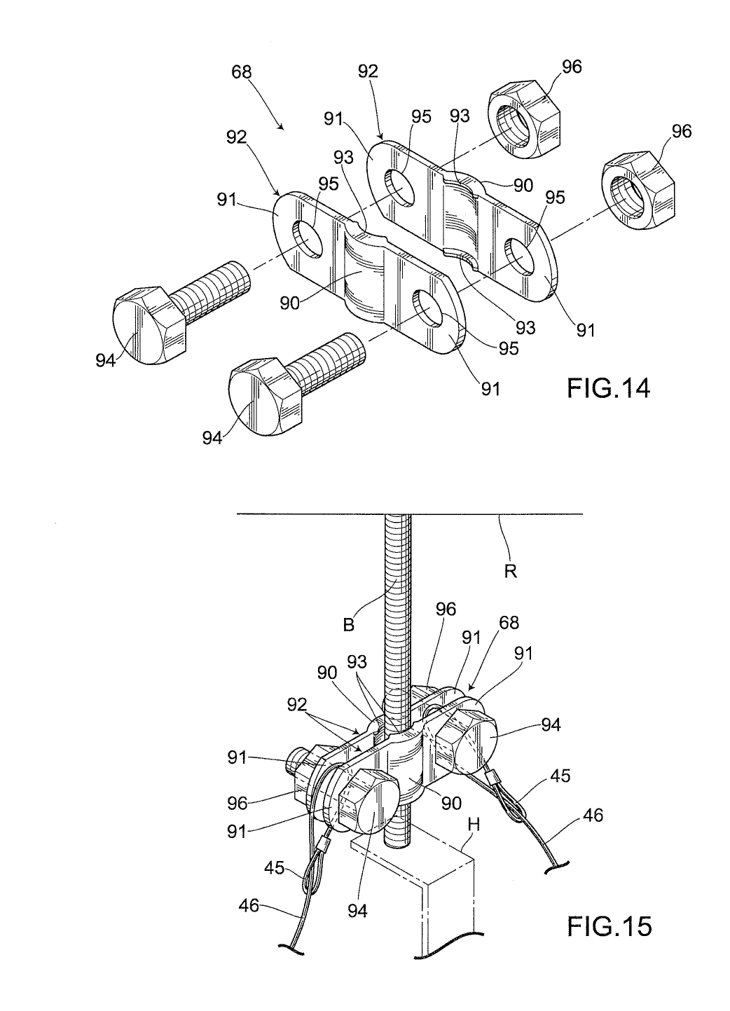

Next, FIG. 14 and FIG. 15 show a fourth embodiment of the present invention. In the figures, the same symbols are attached to parts the same as in FIG. 1 to FIG. 13 and the detailed descriptions of common parts are omitted. According to the present embodiment, as a modified example of the bolt side coupling unit 68, the bolt side coupling unit 68 comprises a pair of the coupling main bodies 92 each including a circular-arc-shaped portion 90 formed by bending a metallic thin plate in an approximately semicircle shape in cross-section and a tongue-shaped piece 91 extending from both ends of the circular-arc-shaped portion 90.

A flange 93 formed so as to be capable of being locked to the thread ridge of the suspension bolt B is employed inside the circular-arc-shaped portion 90, while the tongue-shaped piece 91 includes through-holes 95 which a sixth bolt 94 can penetrate.

The foregoing bolt side coupling unit 68 is attached as follows: by the fastening operation of the sixth bolt 94 and seventh nut 96 via the through-hole 95 in the tongue-shaped piece 91, the portion of the suspension bolt B above the hanger H is held in a sandwiched manner between the circular-arc-shaped portions 90 of the coupling main bodies 92.

Then, the wire member 46 is bound up with the shaft of the sixth bolt 94 to couple the bolt side coupling unit 68 and the wire member 46, so that the bolt side coupling unit 68 and the joist coupling unit 36 are coupled together via the wire member 46.

The bolt side coupling unit 68 according to the present embodiment sandwiches and holds the suspension bolt B by a pair of the coupling main bodies 92. Hence, the bolt side coupling unit 68 can be easily installed on the suspension bolt B mounted with the hanger H.

### Embodiment 5

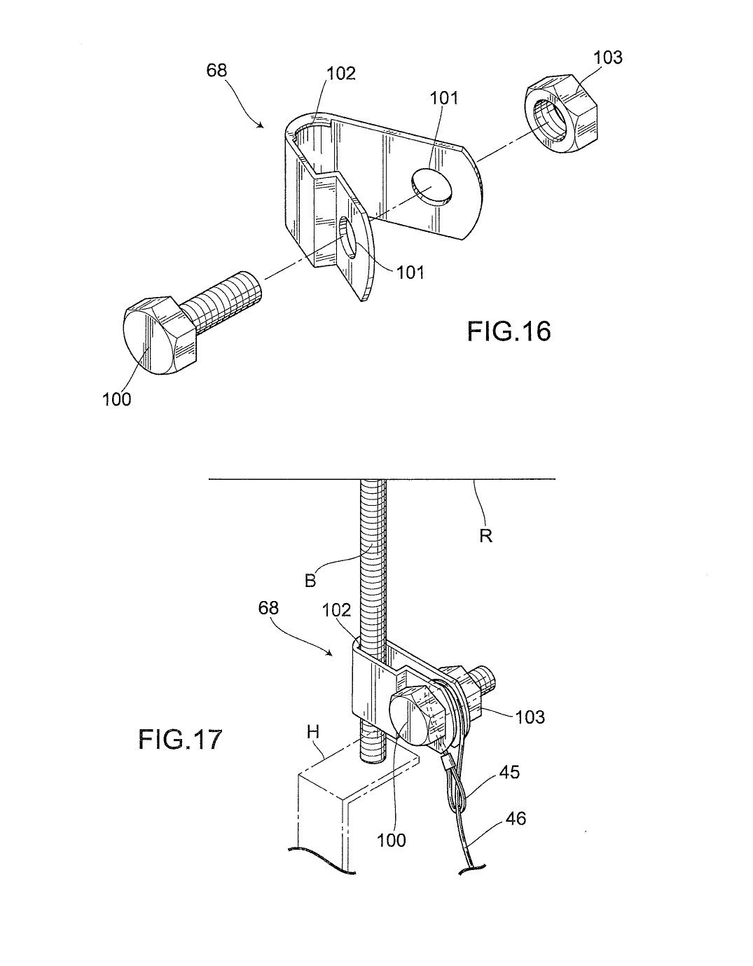

Next, FIG. 16 and FIG. 17 show a fifth embodiment of the present invention. In the figures, the same symbols are attached to parts the same as in FIG. 1 to FIG. 13 and the detailed descriptions of common parts are omitted. According to the present embodiment, as a modified example of the bolt side coupling unit 68, the bolt side coupling unit 68 comprises a metallic clamp formed by bending a metallic thin plate in an approximately U shape in cross section and a through-hole 101 at both ends thereof into which a seventh bolt 100 is insertable. The inside of a circular-arc-shaped portion formed in the bolt side coupling unit 68 is provided with a flange 102 formed so as to be capable of being locked to the thread ridge of the suspension bolt B.

The foregoing bolt side coupling unit 68 is attached by fixedly sandwiching a portion of the suspension bolt B above the hanger H between the circular-arc-shaped portions of the bolt side coupling unit 68 through the fastening operation of the seventh bolt 100 and an eighth nut 103 via the through-holes 101.

Then, the wire member 46 is bound up with the shaft of the seventh bolt 100 to couple the bolt side coupling unit 68 and the wire member 46 together, so that the bolt side coupling unit 68 and the joist coupling unit 36 are coupled together via the wire member 46.

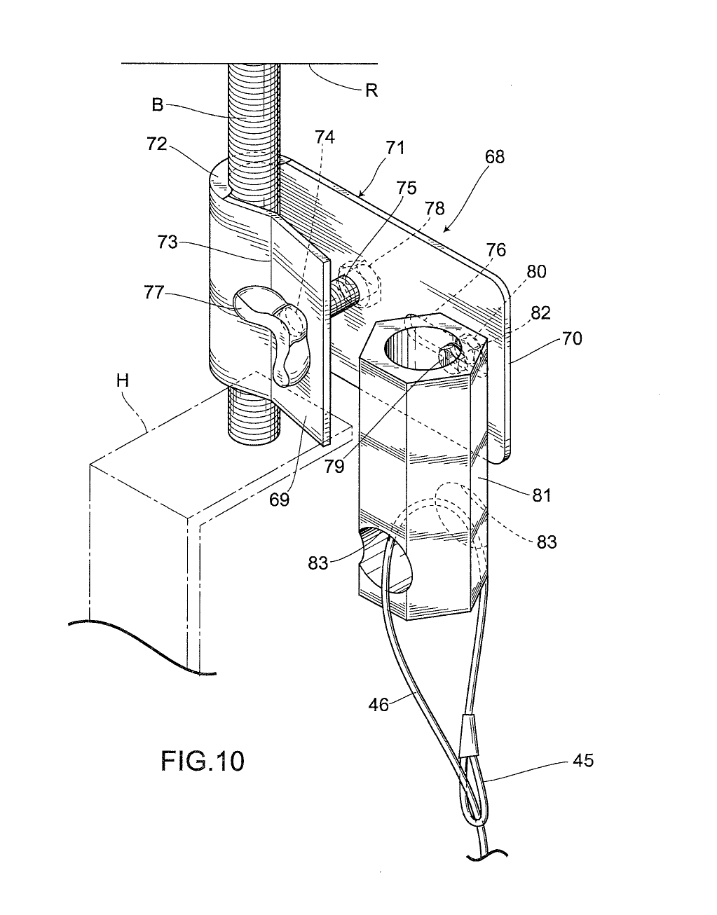

The bolt side coupling unit 68 according to the present embodiment is designed to sandwich and fix the suspension bolt B, as with the bolt side coupling unit 68 shown in FIG. 10. Hence, the bolt side coupling unit 68 can be easily installed on the suspension bolt B mounted with the hanger H.

### Embodiment 6

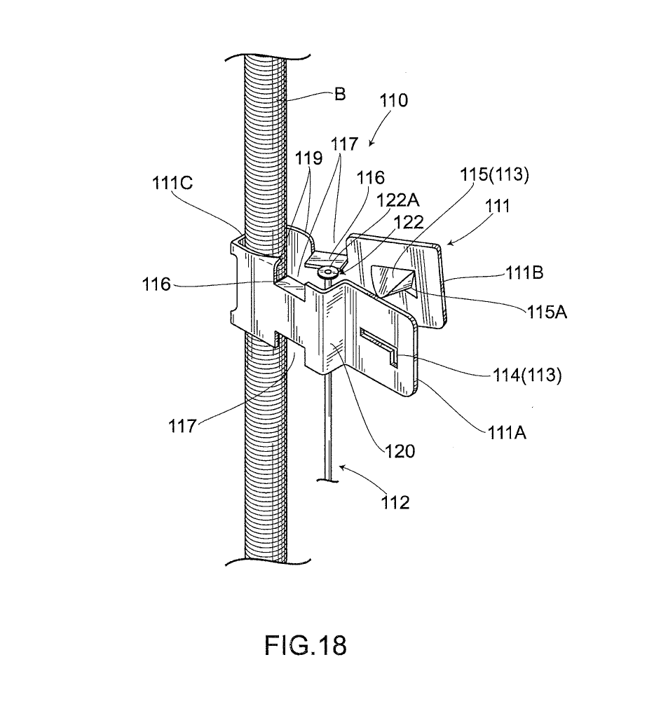

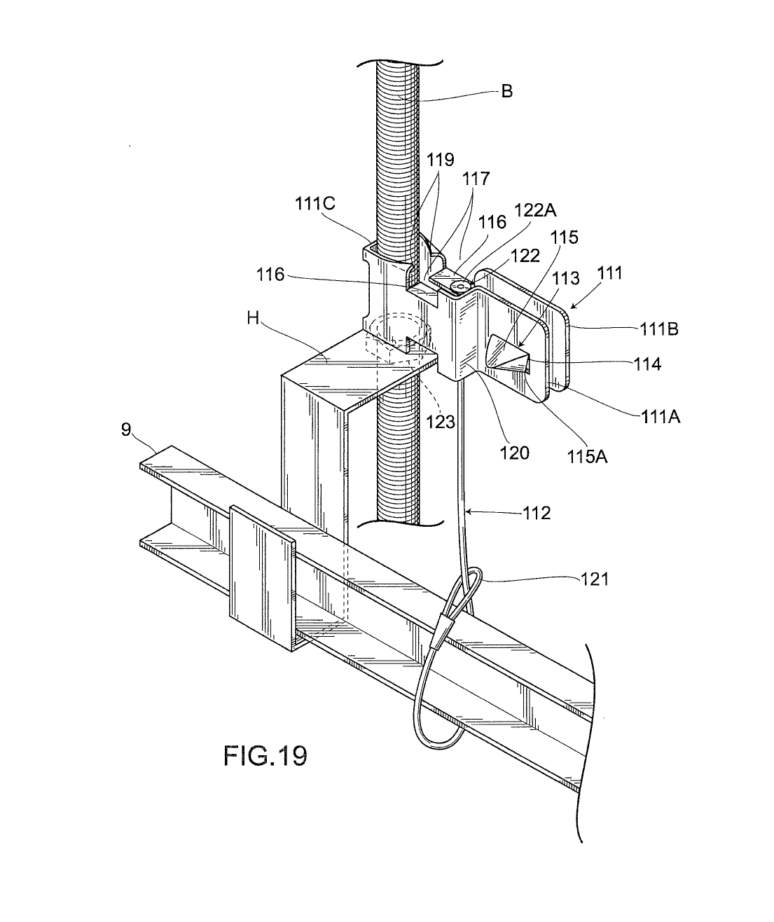

Next, FIG. 18 and FIG. 19 show a sixth embodiment of the present invention. In the figures, the same symbols are attached to parts the same as in FIG. 1 to FIG. 13 and the detailed descriptions of common parts are omitted. In the present embodiment, a coupling structure 110 for coupling the suspension bolt B and the joist support member 9 together is described. The coupling structure 110 according to the present embodiment comprises a clamp 111 installed on the suspension bolt B and a coupling member 112 for coupling the clamp 111 and the furring support member 9 together.

The clamp 111 is formed by bending a metallic thin plate into an approximately U shape in cross section and includes a combining means 113 for combining its both ends 111A, 111B. The combining means 113 includes an approximately L-shaped cutout slit 114 formed on one end 111A of the clamp 111 and a locking portion 115 which is formed on the other end 111B of the clamp 111 and penetrates the cutout slit 114 to be engageable therewith. Here, the locking portion 115 is formed by inwardly raising an approximately triangle cutout portion formed on the other end portion 111B of the clamp 111 to create a piece 115A and then further folding the piece 115A inward.

The upper and lower portions of intermediary portions ranging from a folded portion 111C of the clamp 111 to both the ends 111A, 111B are cut and folded inwardly to form locking pieces 116.

Further, in the cutout portion 117 formed in the clamp 111 by the locking portion 115, a corner portion 118 on the side of the folded portion 111A of the clamp 111 is folded inwardly to form a narrowed portion 119.

Furthermore, a stepped portion 120 is formed between the cutout slit 114 and the locking portion 116 in the other end 111B of the clamp 111.

The coupling member 112 comprises a wire member with a loop 121 on one side and a retaining portion 122 on the other side.

A method for mounting the coupling structure 110 described above is such that the suspension bolt B above the hanger H is arranged inside the folded portion 111C of the clamp 111 and further the retaining portion 122 of the coupling member 112 is arranged in the region surrounded with the locking pieces 116 and stepped portion 120 of the clamp 111, and then the flange 122A of the retaining portion 122 is locked to the upper surface of the locking pieces 116.

Then, when both the ends 111A, 111B are combined by the combining means 113 in the foregoing condition, the suspension bolt B is held by the folded portion 111C and the narrowed portion 119 in a sandwiched manner to fix the clamp 111 to the suspension bolt B and lock the retaining portion 122 of the coupling member 112 to the locking piece 116. As a result, the coupling member 112 is held by the clamp 111 in a manner suspended from the clamp 111. Here, in the combining means 113, one end 115A of the locking portion 115 allowed to penetrate the cutout slit 114 is locked to the edge of the cutout slit 114 and hence both the ends 111A, 111B are combined.

Further, by binding the joist support member 9 with the loop 121 of the coupling member 112 to fix the loop thereto, the clamp 111 and the joist support member 9 are coupled together via the coupling member 112.

As described above, by coupling the joist support member 9 and the suspension bolt B together via the coupling structure 110, even if the hanger H is broken by the shaking of an earthquake or the like and then the ceiling panel P, together with the lattice assembly 10, makes breakaway from the ceiling R, the ceiling panel P can be prevented from falling.

The clamp 111 according to the present embodiment is so structured as to sandwich the suspension bolt B to be fixed thereto. Hence, the clamp 111 can be easily mounted on the suspension bolt B mounted with the hanger H by a nut 123.

The present invention is not limited to the foregoing respective embodiments and various modifications are possible within the scope of the gist of the invention. For example, in respect to the structure of the crossbar clamp 57, it is not limited to the third joist mounting portion 59 and the joist mounting portion 84, but may include the one having both the first joist mounting portion 13 and the second joist mounting portion 15. Further, as an alternative to the bolt side coupling unit 68, a different bolt side coupling unit may be employed which is provided by folding a metallic thin plate in an approximately L shape, allowing one side of the portion thus folded to be provided with a locking portion cut out in a hook-like shape, while allowing the other side thereof to be provided with a through-hole, whereby the locking portion of this different bolt side coupling unit is fastened to the suspension bolt B so that the different bolt side coupling unit is arranged above the hanger H, while the wire member 46 is wound through the through-hole on the other side folded portion, so that the different bolt side coupling unit and the joist coupling unit 36 may be coupled via the wire member 46. Fitting or clamps to be employed at the suspension bolt B side in order to couple the joist coupling unit and the suspension bolt B may be appropriately modified. Furthermore, shapes or set positions of the flanges 72, 92, 102 of the bolt side coupling unit 68 may also be appropriately modified.

### DESCRIPTION OF SYMBOLS

1. joist holder (joist fixing member)
2, 3 joist grooves
4, 5 joist members
9 joist support member
36 joist coupling unit
54 fire-extinguishing equipment
54A sprinkler head (fire-extinguishing unit)
56B bellows tube
56 crossbar
57 crossbar clamp
59 third joist mounting portion
60 vertical plane (first abutting portion)
61 horizontal plane (second abutting portion)
62 region
63 fastening means
68 bolt side coupling unit
84 joist mounting portion
B suspension bolt
H hanger (suspending member)
R ceiling
P ceiling panel

1. A ceiling fire-extinguishing system comprising:
a joist support member held in a manner suspended from a ceiling:
a joist member fixed to a lower portion of said joist support member;
a ceiling panel installed on a lower portion of said joist member; and
a fire-extinguishing equipment including a fire-extinguishing unit on said ceiling panel, said fire-extinguishing equipment being fixed to a crossbar installed in said joist member,
wherein a crossbar clamp for fixing said joist member and said crossbar to each other includes:
a joist mounting portion engageable with an edge of a groove formed in said joist member in a longitudinal direction thereof to slidably hold said joist member;
a first abutting portion provided in a manner capable of being abutted against a lateral face of said crossbar;
a second abutting portion provided in said first abutting portion in a manner capable of being abutted against an upper surface of said crossbar; and
a fastening means for coupling said second abutting portion and said joist mounting portion together, with said crossbar clamp penetrated by said crossbar,
wherein said joist mounting portion includes:
a pair of raised portions formed by bending a pair of both opposite ends of a rectangular-shaped metal clamp main body in parallel to each other, said raised portions being insertable into said groove; and
a locking portion formed by outwardly bending a tip end of said raised portion so as to become engageable with an inner surface of said edge to thereby slidably hold said joist member along said groove.

2. The ceiling fire-extinguishing system according to claim 1, wherein said joist support member is held in a manner suspended from the ceiling via a suspending member installed on a suspension bolt suspended from the ceiling, and said ceiling fire-extinguishing system further includes: a joist coupling unit provided in said joist member; and a bolt side coupling unit provided in said suspension bolt, said joist coupling unit and said bolt side coupling unit being coupled together by a coupling means.

3. The ceiling fire-extinguishing system according to claim 2, wherein said bolt side coupling unit is swingably installed on said suspension bolt.

4. The ceiling fire-extinguishing system according to claim 1, wherein said joist coupling unit provided in said joist member and said joist support member are coupled together by a coupling means.

5. The ceiling fire-extinguishing system according to claim 1, wherein said fire-extinguishing equipment includes a bellows tube.

6. The ceiling fire-extinguishing system according to claim 1, wherein a joist coupling unit installed on said joist member includes a joist coupling body provided in a manner capable of being installed on a groove formed along the longitudinal direction of said joist member and a connecting member for connecting said coupling means for coupling said joist member and a given portion.

7. The ceiling fire-extinguishing system according to claim 6, wherein said connecting member is an internally threaded portion engageable with an externally threaded portion provided in said coupling means.

8. A ceiling fire-extinguishing system comprising:
a joist support member held in a manner suspended from a ceiling;
a joist member fixed to a lower portion of said joist support member;
a ceiling panel installed on a lower portion of said joist member; and
a fire-extinguishing equipment including a fire-extinguishing unit on said ceiling panel, said fire-extinguishing equipment being fixed to a crossbar installed in said joist member,
wherein a crossbar clamp for fixing said joist member and said crossbar to each other includes:
a joist mounting portion engageable with an edge of a groove formed in said joist member in a longitudinal direction thereof to slidably hold said joist member;
a first abutting portion provided in a manner capable of being abutted against a lateral face of said crossbar;
a second abutting portion provided in said first abutting portion in a manner capable of being abutted against an upper surface of said crossbar; and
a fastening means for coupling said second abutting portion and said joist mounting portion together, with said crossbar clamp penetrated by said crossbar,
wherein said joist mounting portion is provided by forming a metal plate in an approximately C shape in cross section so that said joist mounting portion is housed in said joist member with a convexly curved surface thereof being opposed to an inner surface of said joist member, while both ends of said joist mounting portion are provided in a manner engageable with said inner surface of said joist member to slidably hold said joist member along said edge.

9. The ceiling fire-extinguishing system according to claim 8, wherein said joist support member is held in a manner suspended from the ceiling via a suspending member installed on a suspension bolt suspended from the ceiling, and said ceiling fire-extinguishing system further includes: a joist coupling unit provided in said joist member; and a bolt side coupling unit provided in said suspension bolt, said joist coupling unit and said bolt side coupling unit being coupled together by a coupling means.

10. The ceiling fire-extinguishing system according to claim 9, wherein said bolt side coupling unit is swingably installed on said suspension bolt.

11. The ceiling fire-extinguishing system according to claim 8, wherein said joist coupling unit provided in said joist member and said joist support member are coupled together by a coupling means.

12. The ceiling fire-extinguishing system according to claim 8, wherein said fire-extinguishing equipment includes a bellows tube.

13. The ceiling fire-extinguishing system according to claim 8, wherein a joist coupling unit installed on said joist member includes a joist coupling body provided in a manner capable of being installed on a groove formed along the longitudinal direction of said joist member and a connecting member for connecting said coupling means for coupling said joist member and a given portion.

14. The ceiling fire-extinguishing system according to claim 13, wherein said connecting member is an internally threaded portion engageable with an externally threaded portion provided in said coupling means.
